(19) United States
(12) Patent Application Publication
(10) Pub. No.: US 2026/0145249 A1
(43) Pub. Date: May 28, 2026

(54) DRILL BIT WITH REMOVABLE SLEEVE AND METHOD FOR USING THE SAME

(71) Applicant: Axis Innovations, LLC, Lindon, UT (US)

(72) Inventors: Darren Taylor, Lindon, UT (US); Grant Hagen

(21) Appl. No.: 19/391,753

(22) Filed: Nov. 17, 2025

Related U.S. Application Data
(60) Provisional application No. 63/723,973, filed on Nov. 22, 2024.

(51) Int. Cl. B23B 51/08; H02G 3/22

(52) U.S. Cl. CPC B23B 51/08; H02G 3/22; B23B 2251/24

(57) ABSTRACT

An apparatus that includes a drill bit and a sleeve, and method for using the same is disclosed. In one embodiment, an apparatus may include a drill bit that has a shank portion at one end, a lead portion at an opposite end, and an elongated neck portion that connects the shank portion with the lead portion. The apparatus may also include a hollow sleeve that surrounds at least a portion of the elongated neck portion. In one embodiment, a method for using a drill bit and sleeve includes securing the shank portion of the drill bit to a drill chuck, inserting the drill bit and hollow sleeve through a structure, removing the drill bit from the drill chuck, and removing the drill bit from the hollow sleeve such that the hollow sleeve remains within the structure.

### CROSS-REFERENCE TO RELATED APPLICATION

This application claims the benefit of United States Patent Application Serial No. 63/723,973, filed on Nov. 22, 2024, which is incorporated herein by reference in its entirety.

### BACKGROUND

Outdoor lights are commonly used to illuminate exterior areas, such as along footpaths, at the base of trees, or on roof eaves. Installation of outdoor lights often requires drilling a hole through a structure, such as a wall, in order to run wires from inside the structure to a light that is mounted outside the structure. Drilling a hole through a structure, such as exterior and interior walls of a house, and running a wire through the hole can present a variety of challenges. Due in part to the fact that the drilled holes are small, it can be difficult to thread a wire through both walls in a structure. For example, the wire may get bent or tangled within the walls making it extremely difficult to find the corresponding hole in an opposing wall. This difficulty may be compounded if insulation or other materials are present within the inner and outer walls of a house. Thus, an improved apparatus that facilitates threading a wire through the walls of a structure is needed.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address the problems experienced in conventional outdoor lighting systems, including problems associated with passing wires through structures, such as an indoor wall and an outdoor wall.

In one embodiment, an apparatus may include a drill bit that has a shank portion at one end, a lead portion at an opposite end, and an elongated neck portion that connects the shank portion with the lead portion. The apparatus may also include a hollow sleeve that surrounds at least a portion of the elongated neck portion.

In some embodiments, the hollow sleeve may be detachably connected to the drill bit.

In some embodiments, the shank portion of the drill bit may be configured to be secured within a drill chuck.

In some embodiments, the lead portion of the drill bit may include at least one flute and a pointed tip.

In some embodiments, the elongated neck may include a spacing band configured to stabilize a position of the hollow sleeve around the elongated neck portion. In these embodiments, an outer diameter of the spacing band may be less than or equal to an inner diameter of the hollow sleeve.

In some embodiments, an outer diameter of the hollow sleeve may be equal to or less than a largest part of an outer diameter of the lead portion of the drill bit.

In some embodiments, the hollow sleeve may include a first end and a second end. The first end may be closest to the lead portion of the drill bit, the second end may be closest to the shank portion of the drill bit, and a stop ring may be positioned at the first end of the hollow sleeve. In this embodiment, an outer circumference of the stop ring may be larger than the largest part of an outer diameter of the lead portion of the drill bit. Further, in this embodiment the hollow sleeve may include a ring locking mechanism at the second end. The ring locking mechanism may be a recess in all or part of an outer surface of the hollow sleeve that is configured to receive and retain a locking ring. In addition or alternatively, the ring locking mechanism may include a plurality of circular ribs that extend around the outer surface of the hollow sleeve.

In another embodiment, a method may include inserting a drill bit into a hollow sleeve. The drill bit may include a shank portion at one end, a lead portion at an opposite end, and an elongated neck portion that connects the shank portion with the lead portion. The hollow sleeve may surround at least part of the elongated neck portion. The method may further include securing the shank portion of the drill bit to a drill chuck, inserting the drill bit and hollow sleeve through a structure, removing the drill bit from the drill chuck, and removing the drill bit from the hollow sleeve such that the hollow sleeve remains within the structure.

In some embodiments, the method may also include securing a locking ring to the ring locking mechanism.

In some embodiments, the method may also include trimming an amount of hollow sleeve that extends outside of the locking ring.

In some embodiments, the method may also include threading a wire through the hollow sleeve from one side of the structure to an opposite side of the structure.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIGS. 1A-1C illustrate an apparatus according to one embodiment of the present disclosure;

FIGS. 2A-2E illustrate different steps for installing an apparatus of the present disclosure; and

FIG. 3 illustrates a flowchart of an example method for installing an apparatus of the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

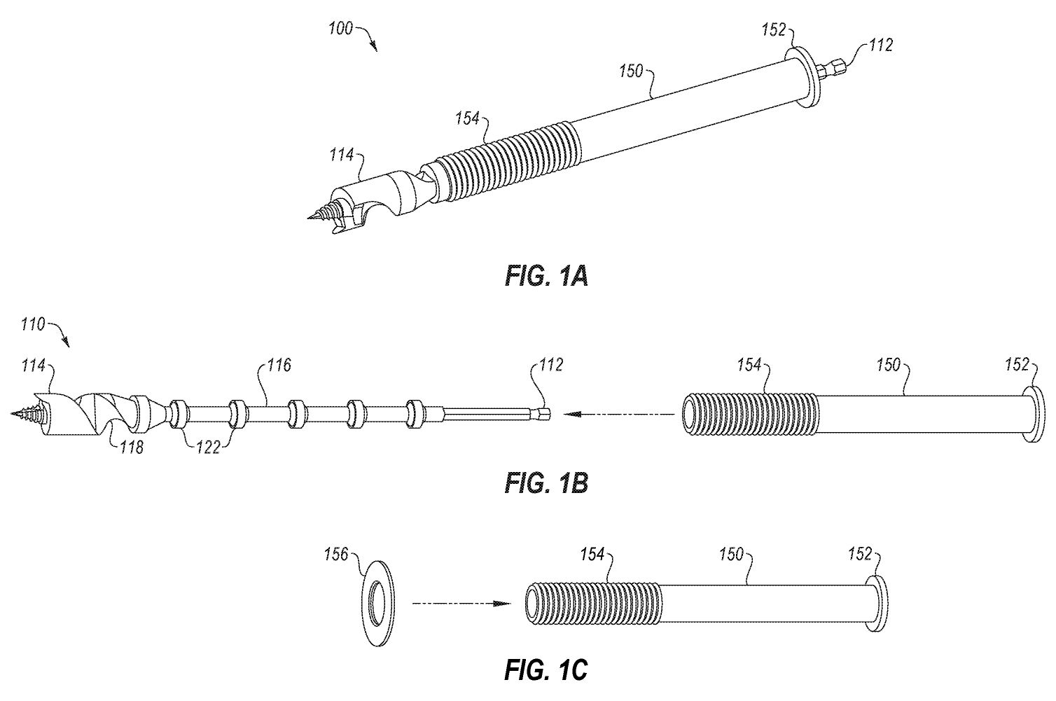

FIGS. 1A-1C illustrate an apparatus 100 that includes a drill bit 110 and a hollow sleeve 150. The drill bit 110 includes a shank portion 112 at one end, a lead portion 114 at an opposite end, and an elongated neck portion 116 that connects the shank portion 112 with the lead portion 114. The shank portion 112 of the drill bit may be shaped and configured to be secured within a drill chuck of a drill. For example, the shank portion 112 may have a polygonal cross-sectional shape. For example, the cross-sectional shape of the shank portion 112 may be triangular, quadrilateral, pentagonal, or hexagonal.

The lead portion 114 of the drill bit 110 includes a spiral channel or flute 118 and a pointed tip 120. In other embodiments, lead portions of drill bits may include, for example, flat heads or spade bits, auger bits, counter-bore bits, holesaw bits, forstner bits, sawtooth bits, counter-sunk bits, and step bits.

The elongated neck portion 116 includes a plurality of spacing members 122. The spacing members 122 may be configured to make contact with an inner surface of the hollow sleeve 150 in order to stabilize the position of the hollow sleeve 150 around the elongated neck portion 116. The spacing members 122 can have any shape or form. For example, in some embodiments, the spacing members may be posts that extent from the surface of the elongated neck portion 116. In the embodiment shown in FIG. 1B, the spacing members 122 are circular disks. In order to fit within and stabilize the hollow sleeve 150, the circumference of an outer portion of the spacing members 122 may be equal to or smaller than the circumference of an inner surface of the hollow sleeve 150.

The hollow sleeve 150 may be made from any material, including metal and plastic. Alternatively, the hollow sleeve 150 may be made from a combination of materials. For example, some portions of the hollow sleeve 150 (which are described in more detail below) may be made from a first material, such as aluminum or another metal, and other portion of the hollow sleeve 150 may be made from a second material, such as plastic.

The hollow sleeve 150 may be configured to be detachably connected to the drill bit 110. In some embodiments, the hollow sleeve may interface with a portion of the drill bit 110 so that the hollow sleeve snaps into place or is maintained in place around the drill bit through a friction connection. In some embodiments the hollow sleeve 150 may rotate with the drill bit 110. In other embodiments the hollow sleeve 150 may be connected to the drill bit 110 in a way that allows the drill bit 110 to rotate inside of the hollow sleeve 150. Regardless of how the hollow sleeve is connected to the drill bit 110, this connection is selectively detachable such that a user may connect and disconnect the hollow sleeve 150 from the drill bit 110.

In some embodiments, the hollow sleeve 150 may be connected to the drill bit 110 by inserting the shank portion 112 and the elongated neck portion 116 into an opening at an end of the hollow sleeve 150, as shown by the arrow in FIG. 1B. The hollow sleeve 150 may abut against the lead portion 114 such that it does not surround the flute 118. The hollow sleeve 150 is also sized such that it does not surround the shank portion 112. The hollow sleeve 150 may be sized such that some part of the elongated neck portion 116 is also not surrounded by the hollow sleeve 150. In short, the hollow sleeve 150 and the elongated neck portion 116 can have any length provided that the hollow sleeve 150 does not cover the shank portion 112 or the flute 118.

The hollow sleeve 150 may be sized so that it is able to fit within a hole that is created by the drill bit 110. In some embodiments, to fit within a hole created by the drill bit 110, the outer diameter of the hollow sleeve may be equal to or less than the largest part of the outer diameter of the lead portion of the drill bit. Thus, when the drill bit 110 is used to create a hole in a structure, the hollow sleeve may be inserted, with the drill bit 110, into the hole created.

The hollow sleeve 150 includes a stop ring 152 at the end of the hollow sleeve that is closest to the shank portion 112. The stop ring 152 may have an outer circumferent that is larger than the largest part of the outer diameter of the lead portion 114 of the drill bit 110. The stop ring 152 prevents the hollow sleeve from being pushed entirely through a hole created by the drill bit. In other words, the hollow sleeve stops and cannot be inserted into a hole created by the drill bit 110 past the stop ring 152.

A ring locking mechanism 154 may be included on an end of the hollow sleeve that is opposite the end on which the stop ring is located. The ring locking mechanism 154 may be a recess in all or part of an outer surface of the hollow sleeve that is configured to receive and retain a locking ring. For example, in the embodiment shown in FIGS. 1A-1C, the ring locking mechanism 154 includes a plurality of circular ribs that extend around the outer surface of the hollow sleeve 150. In other embodiments, the locking mechanism may be threads on the outer surface of the hollow sleeve 150.

A locking ring 156 or another appropriate structure may be pushed onto the hollow sleeve 150 (or rotated with a threaded locking mechanism) to interact with the ring locking mechanism 154 as shown by the arrow in FIG. 1C. For example, the locking ring 156 may interact with the ring locking mechanism 154 similar to how one end of a zip tie retains an opposite end of the zip tie. The ring locking mechanism may be positioned at any location on the hollow sleeve 150 and its position may be based on a thickness of a structure to be drilled. For example, in some embodiments, the plurality of circular ribs may extend across more of the hollow sleeve 150, thereby accommodating a wide range of structure thicknesses.

Modifications, additions, or omissions may be made to the apparatus 100 without departing from the scope of the present disclosure. For example, in some embodiments, the apparatus 100 may include additional components similar to the components illustrated in FIGS. 1A-1C that each may be configured similarly to the components illustrated in FIGS. 1A-1C.

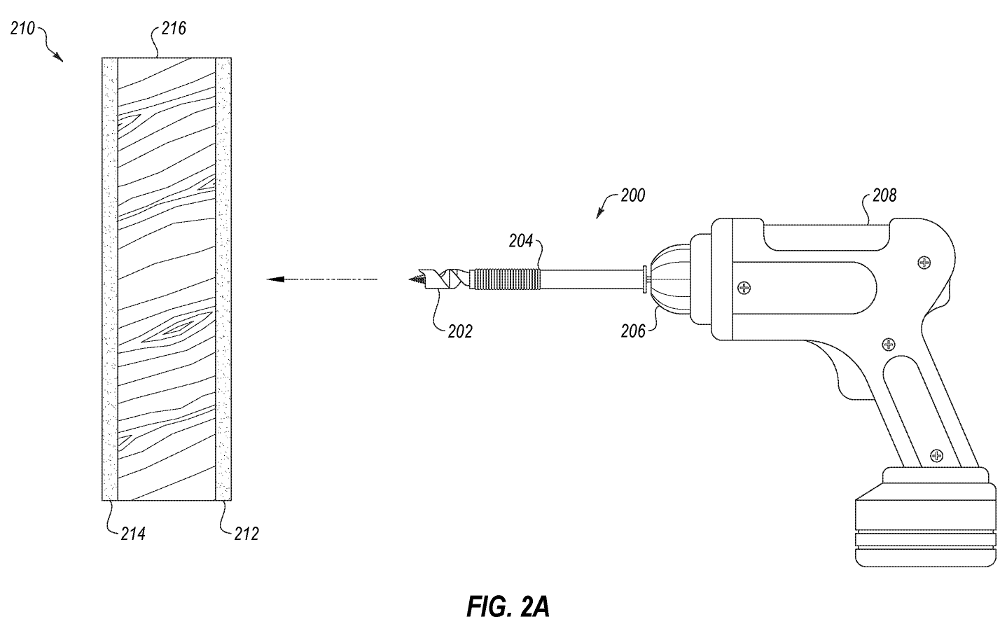

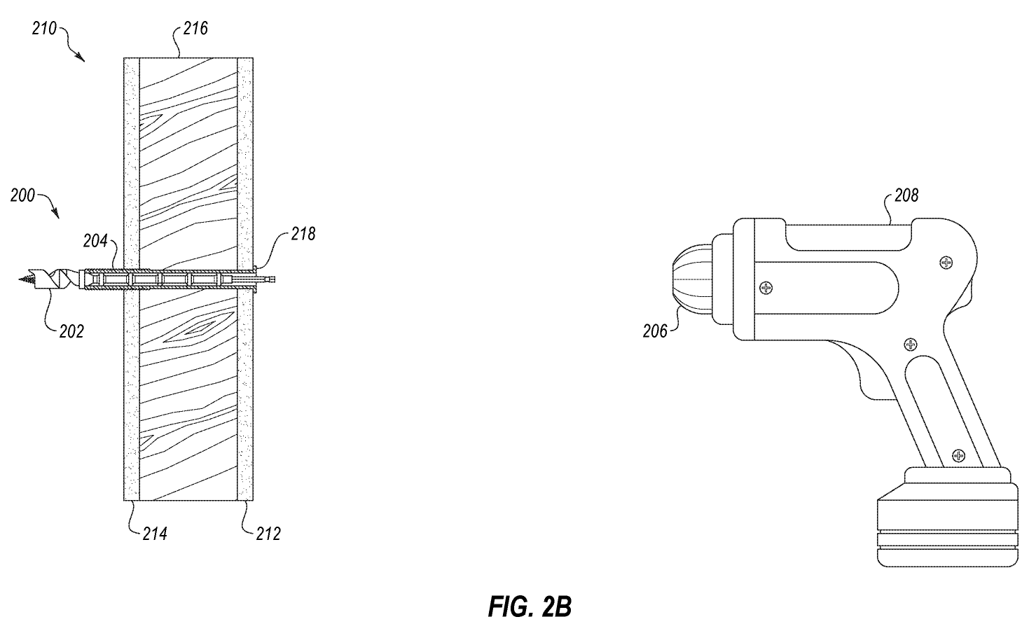

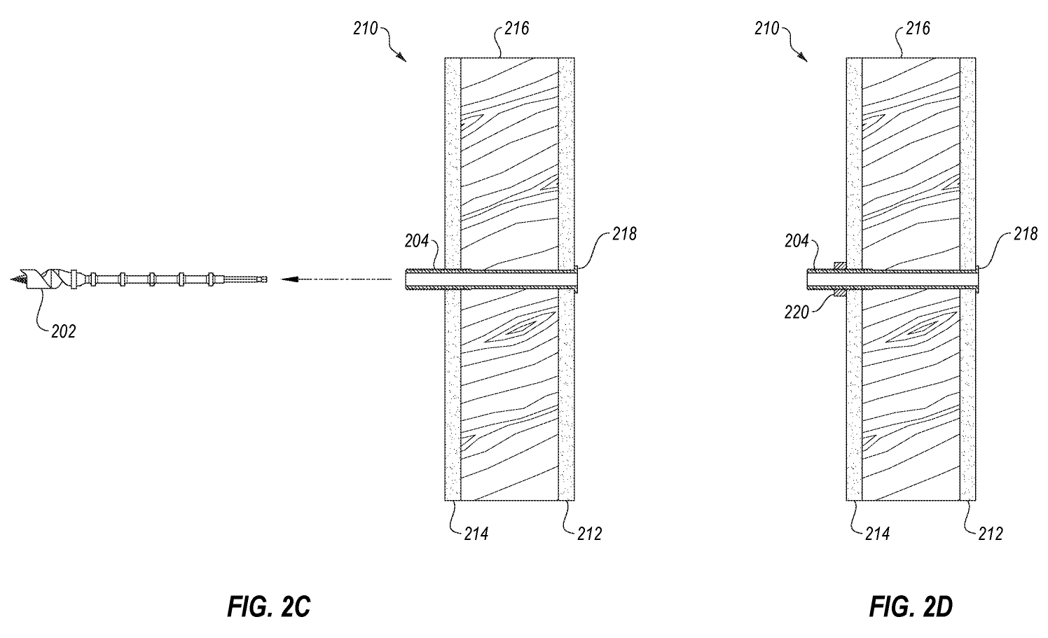

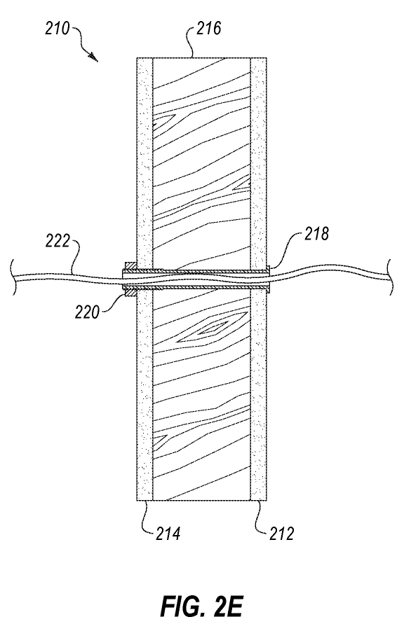

FIGS. 2A-2E illustrate different steps for installing a modified drill bit with removable sleeve according to the present disclosure. FIG. 2A illustrates an apparatus 200 comprising a drill bit 202 and a hollow sleeve 204 into a chuck 206 of a drill 208. In some embodiments, the apparatus 200 may be similar to the apparatus 100 shown in FIG. 1. The drill 208 may be used to insert the apparatus 200 into the structure 210 in the direction shown by the arrow. The structure 210 may include a first wall 212, a second wall 214, and an insulation material 216 contained between the first wall 212 and the second wall 214.

In FIGS. 2B-2E, cross sectional views of the structure 210 and the apparatus 200 are provided. FIG. 2B illustrates the apparatus 200 after it has been inserted through both the first and second walls 212 and 214, as well as through the insulation material 216. The apparatus 200 has also been removed from the drill chuck 206 of the drill 208. As can be seen in FIG. 2B, the entirety of the apparatus 200 does not extend through the first and second walls 212 and 214. A portion of the drill bit 202 as well as a portion of the hollow sleeve 204 extend through both outer sides of the first and second walls 212 and 214. A stop ring 218 prevents the hollow sleeve 204 from passing through the outer side of the first wall 212.

FIG. 2C illustrates the apparatus 200 after the drill bit 202 has been removed from the hollow sleeve 204 in the direction shown by the arrow. The hollow sleeve 204 remains within the structure 210. FIG. 2D illustrates the hollow sleeve 204 with a locking ring 220 secured. The locking ring 220 may interface with a ring locking mechanism on the hollow sleeve 204 such that the locking ring 220 remains attached to the hollow sleeve 204 and prevents the hollow sleeve 204 from pulling back through the hole in the wall 214. Thus, the locking ring 220 on one side of the hollow sleeve 204 and the stop ring 218 on the opposite side maintain the hollow sleeve 204 within the structure 210.

FIG. 2E illustrates the hollow sleeve 204 within the structure 210 after an excess portion of the hollow sleeve 204 that extends outside of the locking ring 220 has be trimmed off. FIG. 2E also illustrates a wire 222 that has been threaded through the hollow sleeve 204 from one side of the structure 210 to an opposite side of the structure 210.

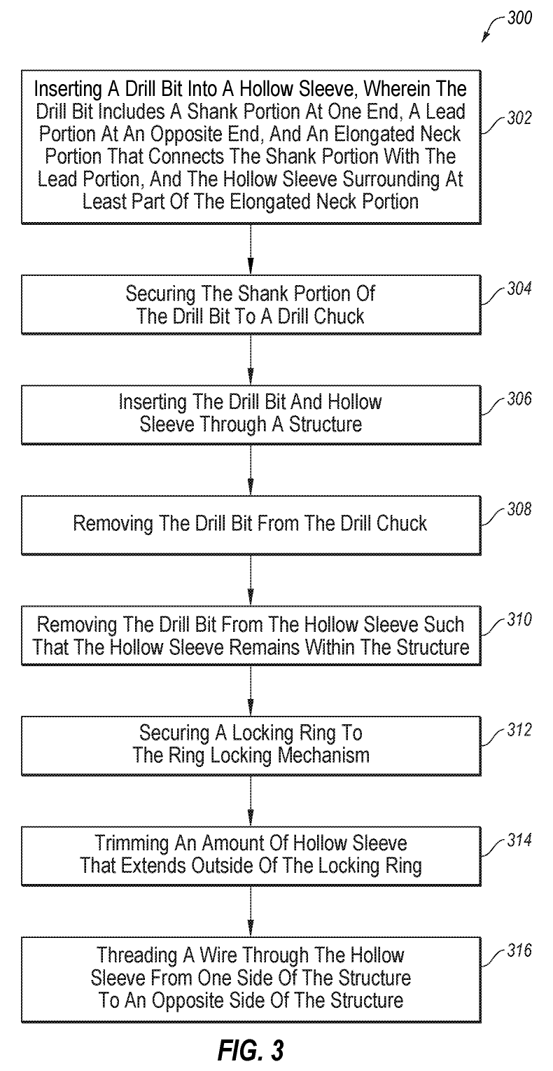

FIG. 3 illustrates a flowchart of an example method 300 for installing an apparatus described herein. The method 300 includes, at action 302, inserting a drill bit into a hollow sleeve, wherein the drill bit includes a shank portion at one end, a lead portion at an opposite end, and an elongated neck portion that connects the shank portion with the lead portion, and the hollow sleeve surrounding at least part of the elongated neck portion. This apparatus may be similar to the apparatus 100 of FIGS. 1A-1C and the apparatus 200 of FIGS. 2A-2E.

The method 300 includes, at action 304, securing the shank portion of the drill bit to a drill chuck. The method 300 includes, at action 306, inserting the drill bit and hollow sleeve through a structure. The structure may include one or more walls and other materials including insulation. The method 300 includes, at action 308, removing the drill bit from the drill chuck and at action 310, removing the drill bit from the hollow sleeve such that the hollow sleeve remains within the structure.

The method 300 includes, at action 312, securing a locking ring to the ring locking mechanism and at action 314, trimming an amount of hollow sleeve that extends outside of the locking ring. Finally, at action 316, the method 300 includes threading a wire through the hollow sleeve from one side of the structure to an opposite side of the structure.

Although the actions of the method 300 are illustrated in FIG. 3 as discrete actions, various actions may be divided into additional actions, combined into fewer actions, reordered, expanded, or eliminated, depending on the desired implementation.

In accordance with common practice, the various features illustrated in the drawings may not be drawn to scale. The illustrations presented in the present disclosure are not meant to be actual views of any particular apparatus (e.g., device, system, etc.) or method, but are merely example representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

What is claimed is:

1. An apparatus comprising:
a drill bit including a shank portion at one end, a lead portion at an opposite end, and an elongated neck portion that connects the shank portion with the lead portion; and
a hollow sleeve that surrounds at least a portion of the elongated neck portion.

2. The apparatus of claim 1, wherein the hollow sleeve is detachably connected to the drill bit.

3. The apparatus of claim 1, wherein the shank portion of the drill bit is configured to be secured within a drill chuck.

4. The apparatus of claim 1, wherein the lead portion of the drill bit includes at least one flute and a pointed tip.

5. The apparatus of claim 1, wherein the elongated neck includes a spacing band configured to stabilize a position of the hollow sleeve around the elongated neck portion.

6. The apparatus of claim 5, wherein an outer diameter of the spacing band is less than or equal to an inner diameter of the hollow sleeve.

7. The apparatus of claim 1, wherein an outer diameter of the hollow sleeve is equal to or less than a largest part of an outer diameter of the lead portion of the drill bit.

8. The apparatus of claim 1, wherein the hollow sleeve includes a first end and a second end, wherein:
the first end is closest to the lead portion of the drill bit,
the second end is closest to the shank portion of the drill bit, and
a stop ring is positioned at the first end of the hollow sleeve.

9. The apparatus of claim 8, wherein an outer circumference of the stop ring is larger than the largest part of an outer diameter of the lead portion of the drill bit.

10. The apparatus of claim 9, wherein the hollow sleeve includes a ring locking mechanism at the second end.

11. The apparatus of claim 10, wherein the ring locking mechanism is a recess in all or part of an outer surface of the hollow sleeve that is configured to receive and retain a locking ring.

12. The apparatus of claim 11, wherein the ring locking mechanism comprises a plurality of circular ribs that extend around the outer surface of the hollow sleeve.

13. A method comprising:
inserting a drill bit into a hollow sleeve, wherein:
the drill bit includes a shank portion at one end, a lead portion at an opposite end, and an elongated neck portion that connects the shank portion with the lead portion, and
the hollow sleeve surrounding at least part of the elongated neck portion;
securing the shank portion of the drill bit to a drill chuck;
inserting the drill bit and hollow sleeve through a structure;
removing the drill bit from the drill chuck; and
removing the drill bit from the hollow sleeve such that the hollow sleeve remains within the structure.

14. The method of claim 13, wherein the hollow sleeve includes a first end and a second end, wherein:
the first end is closest to the lead portion of the drill bit,
the second end is closest to the shank portion of the drill bit, and
a stop ring is positioned at the first end of the hollow sleeve.

15. The method of claim 14, wherein an outer circumference of the stop ring is larger than the largest part of an outer diameter of the lead portion of the drill bit such that the stop ring does not extend through the structure but remains outside of the structure.

16. The method of claim 15, wherein the hollow sleeve includes a ring locking mechanism at the second end.

17. The method of claim 16, wherein the ring locking mechanism is a recess in all or part of an outer surface of the hollow sleeve that is configured to receive and retain a locking ring.

18. The method of claim 17, further comprising:
securing a locking ring to the ring locking mechanism.

19. The method of claim 18, further comprising:
trimming an amount of hollow sleeve that extends outside of the locking ring.

20. The method of claim 13, further comprising:
threading a wire through the hollow sleeve from one side of the structure to an opposite side of the structure.
